(19) United States
(12) Patent Application Publication
(10) Pub. No.: US 2026/0368759 A1
(43) Pub. Date: Nov. 19, 2026

(54) RECOMMENDATION CURATION FOR REAL TIME TRENDING TOPICS

(71) Applicant: eBay Inc., San Jose, CA (US)

(72) Inventors: Yuri Michael Brovman, Miami, FL (US); Nazmul Kabir Chowdhury, Nyack, NY (US); Rashmi Jayakumar, Short Hills, NJ (US); Mengyi Li, San Francisco, CA (US)

(21) Appl. No.: 19/206,723

(22) Filed: May 13, 2025

(51) Int. Cl. G06Q 30/0201; G06F 16/951; G06F 16/9538

(52) U.S. Cl. CPC G06Q 30/0201; G06F 16/951; G06F 16/9538

(57) ABSTRACT

Some aspects relate to technologies for an agentic approach to recommendation curation for real time trending topics. In accordance with some aspects, an indication of a trending topic is received. A first agent performs one or more internet searches to retrieve information regarding the trending topic. A second agent extracts structured information for topic aspects from the retrieved information. A third agent evaluates the structured information for the topic aspects to determine a relevance of each topic aspect. A subset of the topic aspects are selected based on the relevance of each topic aspect. A set of item listings is identified, from item listing data for a listing platform, for a first topic aspect from the subset of topic aspects. An indication of the first topic aspect and the set of item listings for the first topic aspect are provided for presentation on a user device.

### BACKGROUND

Computers and the web have revolutionized access to information, offering an unprecedented volume of data on virtually any topic. While this abundance is a powerful resource for learning, research, decision-making, and various other applications, it also introduces significant technical challenges. Chief among these is the difficulty of retrieving relevant information from the overwhelming flood of digital data, which is often unstructured. Search engines, recommendation systems, and filtering algorithms have been developed to help users navigate this digital ocean, but ensuring accuracy, context-awareness, and relevance remains a complex problem. As the quantity of online content continues to grow, so too does the need for more sophisticated techniques to identify and extract meaningful information efficiently.

### SUMMARY

Some aspects of the present technology relate to, among other things, a system for agentic topic tracking and understanding for various applications. The system employs agents to gather information regarding topics and to analyze the information to understand the topics. These include internet-connected agents that perform multi-step reasoning and research for topics and agents that perform various operations on the data retrieved by the internet-connected agents to understand each topic.

In some configurations, the technology described herein employs an agentic approach to identify and understand trending topics in online sources that are relevant and suitable for a listing platform, such as, for instance, use in performing item retrieval (e.g., search and recommendation) on the listing platform. The system accesses signal data, which can be low-context information such as hashtags and search queries, to identify trending topics. The system then employs an internet-connected agent to gather contextual information to understand why each topic is trending. The system also evaluates the relevance and suitability of each trending topic for the listing platform, ensuring that only pertinent and appropriate topics are considered.

Based on identified trending topics, the system can generate curated collections of item listings from the listing platform to facilitate item retrieval. For a given topic, an internet-connected agent retrieves information regarding the topic, and another agent processes the raw data to provide structured data regarding aspects of the topic. The system then uses another agent to evaluate the topic aspects to identify aspects that present opportunities for item retrieval on the listing platform. For relevant topic aspects, the system employs agents to identify item listings related to these aspects and to evaluate the relevance and quality of the item listings. The system then forms curated collections of item listings, which can be used to enhance item retrieval on the listing platform. This process ensures that the curated collections are highly relevant and of high quality, reflecting different aspects of the trending topics.

Further aspects facilitate the tracking of custom topics specified by users. Given natural language input from a user describing a custom topic to be tracked, a setup agent initially configures agents to gather relevant data for the custom topic and determine whether the data includes any material changes to the topic. After the initial setup, runs are triggered at scheduled intervals. During each run, the configured agents perform multi-step reasoning and research to gather information about the custom topic and then evaluate the data for material changes. When material changes are detected, the system provides notifications to the user, ensuring that they are kept informed about the latest developments in their custom topic. In some cases, the material changes can alternatively or additionally be used to facilitate item retrieval (e.g., search and recommendation) on a listing platform.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing example operations for identifying trending topics that are relevant and suitable for a listing platform in accordance with some implementations of the present disclosure;

FIG. 3 is a block diagram showing example operations for identifying relevant topic aspects of a trending topic in accordance with some implementations of the present disclosure;

FIG. 4 is a block diagram showing example operations for curating collections of item listings for selected topic aspects in accordance with some implementations of the present disclosure;

FIG. 5 is a block diagram showing example operations for generating configuration information to track information for a custom topic in accordance with some implementations of the present disclosure;

FIG. 6 is a block diagram showing example operations for tracking a custom topic specified by user input and identifying material changes in the topic in accordance with some implementations of the present disclosure;

FIG. 7 is a flow diagram showing a method for identifying trending topics that are relevant and suitable for a listing platform in accordance with some implementations of the present disclosure;

FIG. 8 is a flow diagram showing a method for identifying relevant topic aspects of a trending topic in accordance with some implementations of the present disclosure;

FIG. 9 is a flow diagram showing a method for curating collections of item listings for selected topic aspects in accordance with some implementations of the present disclosure;

FIG. 10 is a flow diagram showing a method for generating configuration information to track information for a custom topic in accordance with some implementations of the present disclosure;

FIG. 11 is a flow diagram showing a method for tracking a custom topic specified by user input and identifying material changes in the topic in accordance with some implementations of the present disclosure; and

FIG. 12 is a block diagram of an exemplary computing environment suitable for use in implementations of the present disclosure.

### DETAILED DESCRIPTION

### Overview

The internet serves as a vast repository of information that is often used in various applications to identify trending topics or to gather information around changes in topics over time. For instance, in the context of ecommerce, the internet can be used to identify trending topics, such as products, styles, or events, to tailor marketing strategies and inventory. As another example, users often search the internet to research information about topics, including changes in the topics over time. However, the sheer volume of information available online poses a significant technical challenge for effective topic tracking. Additionally, the dynamic nature of online content, with new information constantly being generated, makes it difficult to keep up with the latest trends and accurately track topics.

Manual tracking of trending topics and topic changes is fraught with inefficiencies. The process is time-consuming, often taking days, weeks, or even months to identify and analyze trends. By the time these trends are recognized, they may already be outdated, especially those that are short-lived. This lag in trend identification can result in missed opportunities for entities who rely on timely information to make informed decisions. Additionally, manual tracking requires significant human effort and expertise, making it a costly and labor-intensive endeavor.

The development of artificial intelligence, including large language models (LLMs), presents a potential opportunity for more effectively tracking topics. However, relying on generic pre-trained LLMs for topic tracking also presents several challenges. These models often struggle to provide accurate information due to their inability to incorporate the latest information. The lag in training means that LLMs may not recognize new or emerging topics, leading to outdated or irrelevant information. Furthermore, the quality of information can vary widely depending on the topic and context, as LLMs may have difficulty disambiguating similar terms or understanding the context of different topics. For example, distinguishing between “the bear” as a movie, a TV show, or an animal requires a deeper understanding than what generic LLMs typically offer, especially when dealing with new topics or dynamically changing topics. This limitation hinders the effectiveness of LLMs in providing precise and contextually relevant insights for topic tracking.

Aspects of the technology described herein address the shortcomings of existing solutions for topic tracking by providing an agentic approach for topic tracking and understanding. Some aspects of the present technology relate to an agentic approach to identifying trending topics and understanding why the topics are trending, as well as determining whether the trending topics are relevant and suitable for a listing platforms. The system identifies trending topics by accessing signal data from online sources such as social media sites, news sites, and search platforms. For a given trending topic, an internet-connected research agent performs multi-step information gathering and reasoning, retrieving relevant information from the internet to understand why the topic is trending. The research agent can refine its search queries iteratively to ensure comprehensive analysis of the trending topic.

The system leverages the information gathered for the trending topic to determine the relevance and suitability of the topic for a listing platform. In particular, a topic relevance agent evaluates the relevance of the trending topic to a listing platform by querying item listing data to determine the extent of item listings related to the topic. Additionally, a topic suitability agent assesses the suitability of the topic for the listing platform by comparing the topic and its context information against predefined guidelines. This process provides for the identification of trending topics that are both relevant and suitable to the listing platform for various applications, such as facilitating item retrieval (e.g., search and recommendation) on the listing platform.

Additional aspects relate to creating curated collections of item listings for trending topics, such as those identified as relevant and suitable for the listing platform. The system employs an internet-connected research agent to gather detailed information about the topic, including information regarding various aspects of the topic. An information extraction agent processes the collected unstructured data to generate structured information regarding different topic aspects. A topic aspect evaluation agent then assesses the relevance of each identified topic aspect, selecting the most pertinent aspects for further processing.

Given a selection of aspects for the topic, an item listing retrieval agent searches for item listings related to each topic aspect. An item listing evaluation agent then evaluates the relevance and quality of the retrieved item listings. A curation agent can then merge, deduplicate, and group the item listings into curated collections based on themes or categories, which can be based on the various topic aspects. The curated collections can then be employed to facilitate item retrieval on the listing platform.

In further aspects, the system facilitates tracking custom topics specified by users by setting up automated monitoring systems. Given a natural language input regarding a topic provided by a user, a setup agent initially configures the monitoring system, which comprises a number of agents. The setup agent is an internet-connected agent that performs multi-step information gathering and reasoning based on the user input and configures the agents to track the topic and identify material changes. In particular, the setup agent configures a data gathering agent to periodically collect relevant data, a material change detection agent to analyze the collected data for material changes, and a scheduling agent to determine the timing of data collection and analysis runs.

After the initial setup, data collection and analysis runs are periodically performed based on a schedule determined by the scheduling agent. During each run, the data gathering agent retrieves information about the custom topic, and the material change detection agent evaluates the data to identify any material changes from previously gathered information for the topic. The system can provide notifications to the user when material changes are detected.

Aspects of the technology described herein provide a number of improvements over conventional topic tracking approaches. In particular, the agentic topic tracking and understanding approaches employed by the technology offer several significant advantages. For example, by leveraging a system of internet-connected agents that perform multi-step reasoning and research, the technology ensures accurate and context-aware identification of trending topics from vast online sources. The agentic approach also addresses the inefficiencies and inaccuracies of manual tracking and generic pre-trained language models, providing timely and relevant insights. The system’s ability to evaluate the relevance and suitability of trending topics for listing platforms enhances the precision of item retrieval, ensuring that only pertinent and high-quality topics that comport with content policies are considered. Additionally, the technology facilitates the creation of curated collections of item listings, which improves item retrieval relevance by presenting highly relevant and organized information. Further, the system’s capability to track custom topics specified by users and notify them of material changes ensures that users remain informed about the latest developments in their areas of interest. Overall, the technology described herein provides robust and efficient solutions for navigating the overwhelming volume of digital data, facilitating the extraction of meaningful and actionable information.

### Example System for Agentic Topic Tracking and Understanding

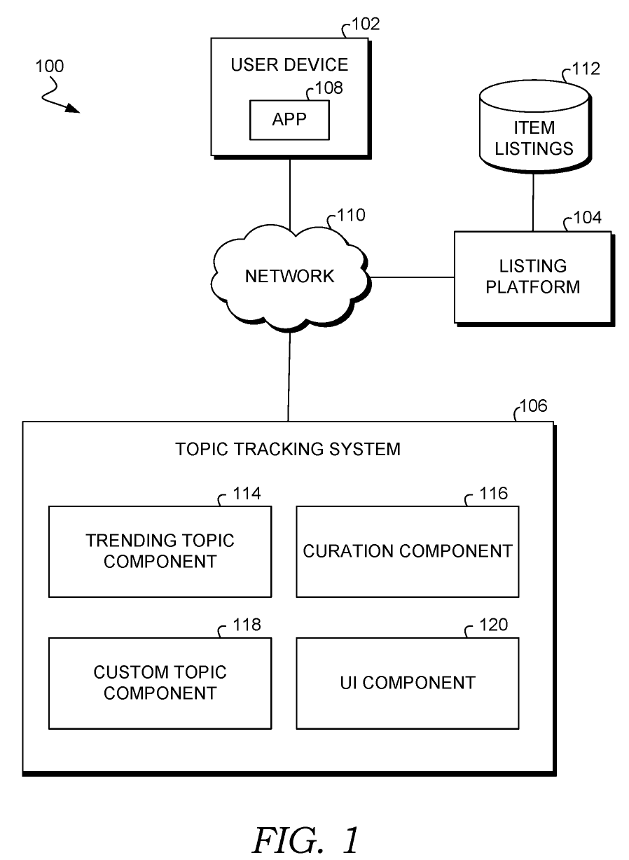

With reference now to the drawings, FIG. 1 is a block diagram illustrating an exemplary system 100 for that employs agents to track and understand topics from digital sources in accordance with implementations of the present disclosure. In some aspects, the system 100 also generates curated collections of item listings for trending topics that can be used, for instance, for item retrieval. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

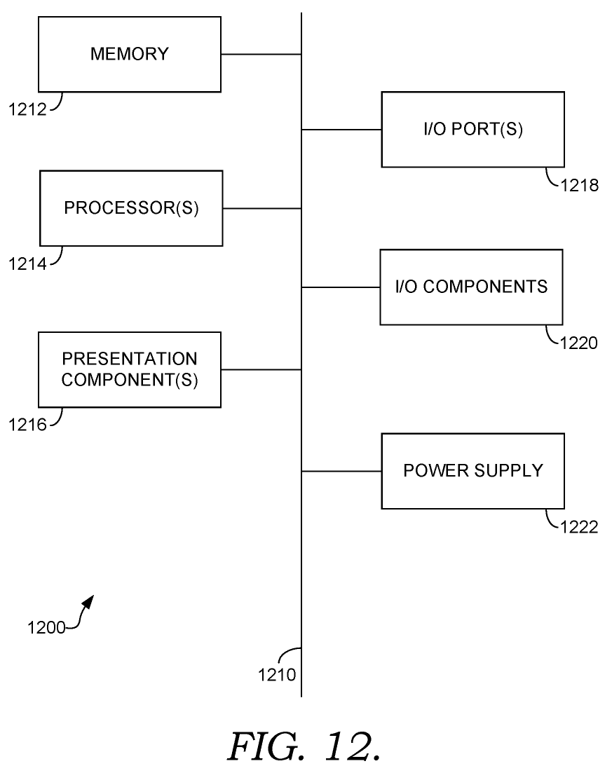

The system 100 is an example of a suitable architecture for implementing certain aspects of the present disclosure. Among other components not shown, the system 100 includes a user device 102, a listing platform 104, and a topic tracking system 106. Each of the user device 102, the listing platform 104, and the topic tracking system 106 shown in FIG. 1 can comprise one or more computer devices, such as the computing device 1200 of FIG. 12, discussed below. As shown in FIG. 1, the user device 102, the listing platform 104, and the topic tracking system 106 can communicate via a network 110, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the listing platform 104 and the topic tracking system 106 could each be provided by multiple server devices collectively providing the functionality of the listing platform 104 and the topic tracking system 106 as described herein. Additionally, other components not shown may also be included within the network environment.

The user device 102 can be a client device on the client-side of the system 100, while the listing platform 104 and the topic tracking system 106 can be on the server-side of the system 100. The listing platform 104 and/or the topic tracking system 106 can each comprise server-side software designed to work in conjunction with client-side software on the user device 102 so as to implement any combination of the features and functionalities discussed in the present disclosure. For instance, the user device 102 can include an application 108 for interacting with the listing platform 104 and/or the topic tracking system 106. The application 108 can be, for instance, a web browser or a dedicated application for providing functions, such as those described herein. This division of the system 100 is provided to illustrate one example of a suitable environment, and there is no requirement for each implementation that any combination of the listing platform 104 and the topic tracking system 106 remain as separate entities. For instance, in some aspects, the topic tracking system 106 is a part of the listing platform 104. While the system 100 illustrates a configuration in a networked environment with a separate user device, listing platform, and topic tracking system, it should be understood that other configurations can be employed in which aspects of the various components are combined.

The user device 102 may comprise any type of computing device capable of use by a user. For example, in one aspect, a user device may be the type of computing device 1200 described in relation to FIG. 12 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the listing platform 104 and/or the topic tracking system 106 via the user device 102.

The listing platform 104 can be implemented using one or more server devices, one or more platforms with corresponding application programming interfaces, cloud infrastructure, and the like. The listing platform 104 generally provides, to user devices such as the user device 102, item listings describing items (physical or digital) available for purchase, rent, streaming, download, etc. For instance, the listing platform 104 could comprise an e-commerce platform, in which listed products or services are available for purchase by users of the user device 102 upon navigation to the listing platform 104.

The functionality of the listing platform 104 includes provision of interfaces enabling surfacing of item listings for items to users of the listing platform 104. Item data for item listings available via the listing platform 104 are stored by the item listings data store 112. The item data for each item listing may include, for instance, information relating to an item comprising one or more of: an item title, an item description, a category, a price in a currency, reviews, images of the item, shipment options, a rating, a condition of the item, a size of the item, a color of the item, etc. The item data can include structured data (attribute name-attribute value pairs) and unstructured text. In some aspects, each item listing is also associated with one or more categories from a category hierarchy for the listing platform 104 (e.g., using category identifiers), including meta-categories and leaf categories. For example, the meta-categories are each divisible into subcategories (or branch categories), whereas leaf categories are not divisible.

The topic tracking system 106 provides an agentic computing environment that performs topic tracking and understanding. In some aspects, the topic tracking system 106 identifies trending topics in online sources and employs a number of agents to analyze the trending topics. As described in further detail below, the topic tracking system 106 can leverage agents to retrieve information regarding the trending topics from digital sources to determine trending context information that describes the reasons why the topics are trending. The topic tracking system 106 can also determine whether each trending topic is relevant and suitable to the listing platform 104 based at least in part of the trending context information for the trending topic. In some aspects, given an identified topic, the topic tracking system 106 can employ agents to identify aspects of the trending topic, evaluate the topic aspects to identify ones that present opportunities for item retrieval for the listing platform 104, and generate curated item listings from the listing platform 104 for the topic aspects. Those curated item listings can then be employed by the listing platform 104 to perform item retrieval for user devices, such as the user device 102. In still further aspects, the topic tracking system can employ agents to facilitate tracking custom topics specified by users.

As shown in FIG. 1, the topic tracking system 106 includes a trending topic component 114, a curation component 116, a custom topic component 118, and a user interface component 120. The components/modules of the topic tracking system 106 may be in addition to other components/modules that provide further additional functions beyond the features described herein. Additionally, in various configurations of the technology described herein, the topic tracking system 106 can include only a portion of the components shown in FIG. 1.

The topic tracking system 106 can be implemented using one or more server devices, one or more platforms with corresponding application programming interfaces, cloud infrastructure, and the like. While the topic tracking system 106 is shown separate from the listing platform 104 and the user device 102 in the configuration of FIG. 1, it should be understood that in other configurations, some of the functions of the topic tracking system 106 can be provided on the listing platform 104 and/or the user device 102. Additionally, while the components/modules are shown as part of the topic tracking system 106, in other configurations, one or more of the components and/or modules thereof can be provided by the listing platform 104 or another location not shown in FIG. 1. The components/modules can be provided by a single entity or multiple entities.

In some aspects, the functions performed by components/modules of the topic tracking system 106 are associated with one or more applications, services, or routines. In particular, such applications, services, or routines may operate on one or more user devices, servers, may be distributed across one or more user devices and servers, or be implemented in the cloud. Moreover, in some aspects, these components/modules of the topic tracking system 106 may be distributed across a network, including one or more servers and client devices, in the cloud, and/or may reside on a user device. Moreover, these components/modules, functions performed by these components/modules, or services carried out by these components/modules may be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed across other components/modules.

In accordance with aspects of the technology described herein, the trending topic component 114, the curation component 116, and the custom topic component 118 employ agents to perform the operations as will be described in further detail below. As used herein, agents are software components or programs that autonomously or semi-autonomously perform tasks, often interacting with their environment or other agents, to achieve specific goals or provide particular functionalities. Agents typically act independently or semi-independently, without constant direct intervention from humans, and may adapt or react dynamically based on input from their environment. The agents can be, for instance, software agents or artificial intelligence (AI) agents. A software agent generally refers to an autonomous program that performs specific tasks within software systems. An AI agent is a type of agent that utilizes artificial intelligence (e.g., machine learning techniques and/or neural networks) to perform tasks.

In the context of AI agents, each agent can comprise, for instance, a language model that includes a set of statistical or probabilistic functions to perform NLP in order to understand, learn, and/or generate human natural language text. For example, a language model can be a tool that determines the probability of a given sequence of words occurring in a sentence or other natural language sequence. A language model is called an LLM when it is trained on an enormous amount of data and/or has a large number of parameters. These models have capabilities ranging from writing a simple essay to generating complex computer codes – all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

In accordance with some aspects, each AI agent comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, each AI agent can be a pre-trained model that has not been fined-tuned. In other configurations, each AI agent can be a model that is built and trained from scratch or a pre-trained model that has been fine-tuned. In such configurations, each AI agent can be trained or fine-tuned for a particular task using training data. For instance, the training data could comprise training samples, where each training sample can include input data and ground truth data.

During model training, weights associated with each neuron in a model can be updated. Originally, an AI agent can comprise random weight values or pre-trained weight values that are adjusted during training. In one aspect, an AI agent is trained using backpropagation. The backpropagation process comprises a forward pass, a loss function, a backward pass, and a weight update. For instance, a forward pass could comprise providing a sample input from a training sample to the AI agent, which generates an output. A loss could then be determined, for instance, based on the output and the ground truth data from the training sample, and weights of the AI agent are updated based on the loss. This process is repeated using the training data. The goal is to update the weights of each neuron (or other model component) to cause the AI agent to produce useful output. Once trained, the weight associated with a given neuron can remain fixed. The other data passing between neurons can change in response to a given input. Retraining the network with additional training data can update one or more weights in one or more neurons. In addition to or in lieu of model training, pre-configured prompts can be used to cause the AI agents to perform certain tasks. The prompts can include text that instruct the AI agents regarding the tasks each AI agent performs.

The trending topic component 114 of the topic tracking system 106 identifies trending topics from signal data obtained from various online sources, such as, for instance, social media sites, news sites, and search platforms. In some aspects, the signal data accessed by the trending topic component is low-context information that includes an indication of one or more topics but lacks detailed context around the topic(s). For example, the signal data could include keywords, hashtags, and search queries from the various online sources.

For each topic identified from signal data, the trending topic component 114 performs multi-step reasoning and research to understand reasons why the topic is trending and provides trending context information describing those reasons. Based on the trending context information for a topic, the trending topic component 114 determines if the topic is relevant to and suitable for the listing platform 104. Relevance is based on the extent to which the listing platform 104 has item listings that are pertinent to the topic. Suitability is based on the extent to which the topic violates or comports with guidelines for the listing platform 104 to ensure the topic aligns with content policies.

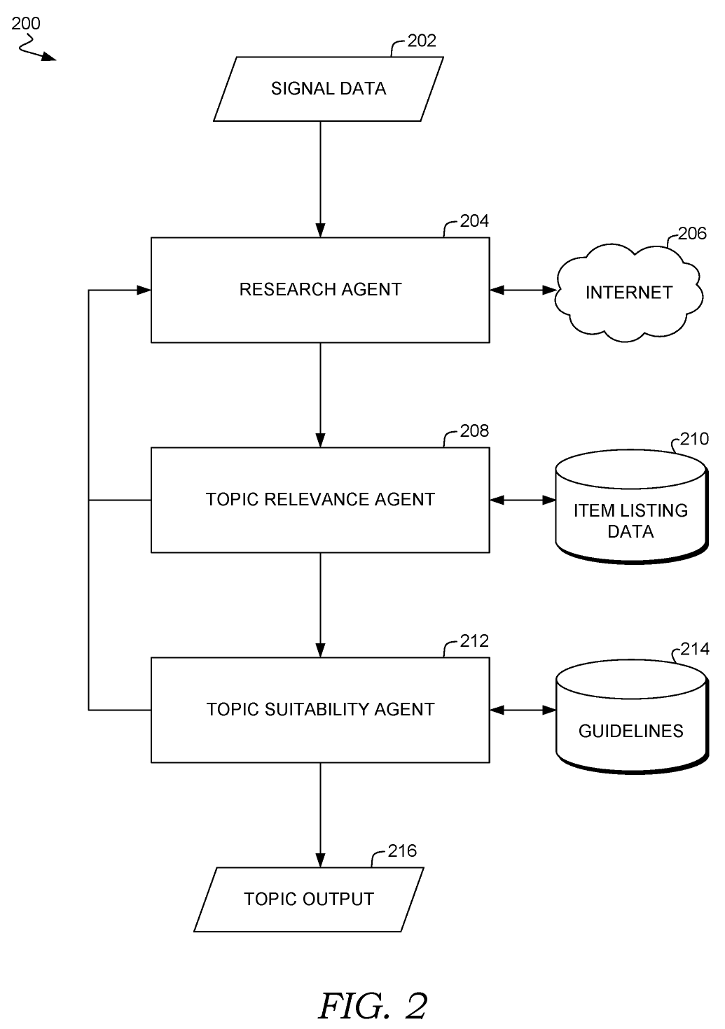

FIG. 2 provides a block diagram that illustrates example operations 200 for identifying trending topics that are relevant and suitable for a listing platform that can be performed, for instance, by the trending topic component 114 in accordance with some aspects of the technology described herein. As described in further detail below, the operations 200 are performed using a number of agents, including a research agent 204, a topic relevance agent 208, and a topic suitability agent 212. While only a single research agent 204, a single topic relevance agent 208, and a single topic suitability agent 212 are shown in FIG. 2, each can comprise one or more agents that perform the operations described herein.

As shown in FIG. 2, the operations 200 begin by accessing signal data 202. As described above, the signal data 202 can be gathered from various online sources, such as, for instance, social media sites, news sites, and search platforms, and, in some aspects, the signal data 202 can be low-context information, such as keywords, hashtags, and search queries.

Topics are identified from the signal data 202 for further analysis. This topic identification can be performed by a research agent 204 or another component not shown in FIG. 2 using a variety of different techniques. For instance, natural language processing (NLP) techniques can be used to understand and interpret human language from online sources, extracting key phrases from the signal data 202. Machine learning algorithms can also be used to categorize this information, recognizing patterns and correlations that indicate trending topics. Social media analytics tools track engagement metrics such as likes, shares, and comments to gauge the popularity of specific topics. Web scraping enables the collection of data from websites, which can be processed to identify frequently discussed topics. Additionally, search engine analytics provide insights into what users are searching for based on their search queries, highlighting shifts in public interest. In some aspects, topics are selected for further analysis by analyzing frequency and patterns of the topics in the signal data 202. For instance, a topic could be selected based on identifying the topic as trending given an increase in occurrence of the topic in the signal data 202 over a certain time period. By using any combination of these techniques, the system can effectively pinpoint trending topics across the digital landscape.

Given a trending topic identified from the signal data 202, the research agent 204 performs multi-step information gathering and reasoning regarding the identified topic. The research agent 204 comprises an internet-connected agent (e.g., an internet-connected LLM) that has real-time or near-real-time access to the internet 206 to retrieve up-to-date information beyond its training data. Unlike static LLMs that rely solely on pre-trained knowledge (which is fixed at a certain cutoff date), an internet-connected LLM can perform searches or query APIs to obtain data from online sources and enhance its responses with current or specific information. The online sources can include, for instance, search engines, websites, news sites, APIs of specific platforms (e.g., weather APIs, stock market APIs, encyclopedia APIs, or other structured services), databases or knowledge graphs, and custom or enterprise data.

In accordance with the present technology, the research agent 204 conducts internet searches to retrieve relevant information about the topic, aiming to understand why the topic is trending. The research agent 204 can refine its search queries based on the information it gathers over multiple iterations, ensuring a comprehensive analysis of the topic. This process allows the research agent 204 to generate trending context information providing a detailed understanding of why the topic is trending. The trending context information output by the research agent 204 can comprise text (e.g., natural language text) describing the trending context for the topic, such as text that specifies one or more reasons why the topic is trending. As an example to illustrate, suppose the system determines a particular actor is a currently trending topic. The research agent 204 could then perform research via online searches to determine that the actor is trending based on a blockbuster movie with the actor that was just released.

The topic relevance agent 208 evaluates the relevance of the identified topic to the listing platform. In particular, the topic relevance agent 208 determines whether the topic is pertinent to item listings available on the listing platform. In some aspects, the topic is used alone when performing the topic relevance evaluation; while in other aspects, the trending context information generated by the research agent 204 is also used when performing the topic relevance evaluation.

The topic relevance agent 208 employs the topic and/or trending context information to query the item listing data 210 for the listing platform to identify item listings relevant to the topic. The topic relevance agent 208 can determine an extent to which there are item listings available on the listing platform related to the topic and/or its corresponding trending context information such that the topic is relevant for performing item retrieval on the listing platform. For instance, continuing the example above in which the topic is an actor who is trending based on a recent movie, the topic relevance agent 208 can determine the extent to which any item listings on the listing platform are relevant to the actor and/or the movie.

In some aspects, the topic relevance agent 208 generates at least one relevance score for the topic based on the analysis and compares the relevance score to a relevance threshold to determine if the topic is relevant to the listing platform and therefore should be considered for further analysis. The relevance score for the topic can be, for instance, a function of individual relevance scores of the top N item listings returned from querying the item listing data 210.

The topic suitability agent 212 assesses the suitability of the topic for the listing platform. In particular, the topic suitability agent 212 uses guidelines 214 to evaluate the suitability of the topic based on its corresponding trending context information. The guidelines 214 can comprise natural language text setting forth policies, standards, and/or other requirements for determining the suitability of topics for the listing platform. The topic suitability agent 212 can comprise an LLM that processes the topic and its trending context information to determine whether they align with the policies, standards, or other requirements specified by the guidelines 214. For instance, in the example in which an actor is trending based on a recent movie release, the topic suitability agent 212 could determine the topic is suitable. Alternatively, if the actor is trending because of some scandal or other negative publicity, the topic suitability agent 212 could determine the topic is unsuitable.

In some aspects, the topic suitability agent 212 can generate a suitability score based on an extent to which the topic and its trending context information comport with the guidelines 214. The suitability score can be compared to a suitability threshold to determine if the topic and its trending context are suitable and therefore should be considered for further analysis.

While FIG. 2 is shown with only a single research agent 204, a single topic relevance agent 208, and a single topic suitability agent 212, aspects of the technology can employ any number of agents to perform the tasks of each of these agents as described herein. In some aspects, relevance and suitability can each be determined using agent voting, where multiple agents collectively reach an agreement as to relevance and suitability of topics by voting.

As shown in FIG. 2, if a topic is determined to be irrelevant or unsuitable by the topic relevance agent 208 and the topic suitability agent 212, respectively, the research agent 204 can be instructed to gather additional trending context information, for instance, by performing additional multi-step information gathering and reasoning regarding the topic. After additional trending context information is gathered, the topic can be evaluated again for relevance and/or for suitability using the additional trending context information. This can be performed over several iterations until the topic is determined to be relevant and suitable or until a certain number of iterations have been performed, in which case the topic can be considered irrelevant and/or unsuitable for the listing platform and discarded.

When a trending topic is found to be relevant and suitable, topic output 216 is provided that identifies the trending topic. The topic output 216 can also include additional information such as the reasons why the topic is trending. In some aspects, the system provides an indication of the topic (with or without an indication of the reasons why the topic is trending), which is displayed on a user device of an administrator of the listing platform. This allows the administrator to review the topic and/or reasons why the topic is trending to determine whether to use the topic for item retrieval purposes on the listing platform. In some aspects, the topic output 216 is provided to downstream operations of the system to facilitate automated item retrieval on the listing platform relevant to the topic.

This approach enables the listing platform to offer timely and relevant item listings (e.g., for search and/or recommendation) based on trending topics, enhancing the item retrieval relevance for the listing platform. In some aspects, when a search engine of the listing platform receives search queries from users, the search engine can identify search queries that are relevant to trending topics and employ the trending topics to select/rank item listings to return as search results. For instance, suppose a user submits a search query for “nike basketball shoes” and the search system determines the search query is relevant to the topic “Air Jordans,” which is trending because a new version was recently released. Based on that determination, the system could provide search results that provide higher relevance to Air Jordan item listings.

In some aspects, trending topics can be used to select item listing recommendations to provide to user devices accessing the listing platform. For instance, a trending topic could be used to provide item listing recommendations presented on the homepage of the listing platform. This could be provided for all users or could be provided for users for which the topic is relevant (e.g., based on user information available to the system). As another example, a trending topic could be used to provide item recommendations for presentation on an item page (e.g., a product page) for an item listing when the trending topic is relevant to the item listing. For instance, suppose an item page presents an item listing for a pair of Nike running shoes, and the system determines the trending “Air Jordans” topic to be relevant. In that example, item listing recommendations included on the item page could include recommendations for Air Jordan item listings.

With reference again to FIG. 1, the curation component 116 of the topic tracking system 106 creates curated collections of item listings from the listing platform 104 for trending topics, such as relevant and suitable trending topics identified by the trending topic component 114. The curation component 116 employs agents that identify topic aspects regarding a given trending topic and evaluates the topic aspects. Based on the evaluation, the curation component 116 generates one or more curated collections of item listings for certain topic aspects. Each curated collection includes a set of one or more item listings from the listing platform 104 that are relevant to a topic aspect. These curated collections can be used to enhance item retrieval for the listing platform 104, for instance, by using the collections when performing search and recommendation on the listing platform.

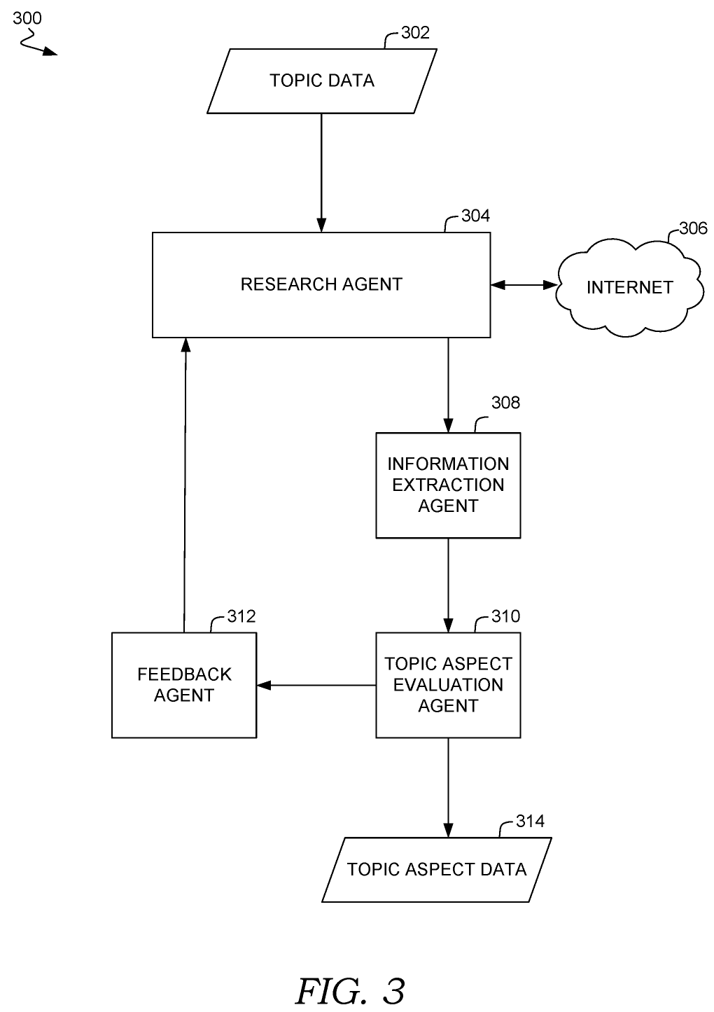

FIG. 3 provides a block diagram that illustrates example operations 300 for identifying relevant topic aspects of a trending topic that can be performed, for instance, by the curation component 116 in accordance with some aspects of the technology described herein. The operations 300 are performed using a number of agents, including a research agent 304, an information extraction agent 308, a topic aspect evaluation agent 310, and a feedback agent 312. While only a single research agent 304, a single information extraction agent 308, a single topic aspect evaluation agent 310, and a single feedback agent 312 are shown in FIG. 3, each can comprise one or more agents that perform the operations described herein.

As shown in FIG. 3, the operations 300 begin by accessing topic data 302 for a given topic. In some aspects, the topic can be a trending topic identified as relevant and suitable using the operations 200 of FIG. 2 discussed above. The topic data 302 can provide only an indication of the topic or can provide additional information, such as trending context information for the topic identified during the operations 200 of FIG. 2 discussed above.

The research agent 304 performs multi-step information gathering and reasoning regarding the topic. Similar to the research agent 204 of FIG. 2, the research agent 304 can comprise an internet-connected LLM that can access and retrieve information from the internet 306 in real-time. Also similar to the research agent 204, the research agent 304 conducts internet searches to retrieve relevant information about the topic and can refine its search queries based on the information it gathers over multiple iterations, ensuring a comprehensive analysis of the topic. However, while the research agent 204 generates topic context information regarding why the topic is trending, the research agent 304 generates topic information that provides a collection of information regarding the topic that can be used to identify topic aspects that can be used for item retrieval. The topic information output by the research agent 304 can comprise text (e.g., natural language text) describing the topic.

The topic information gathered by the research agent 304 is provided to the information extraction agent 308 to process the raw data and extract structured information regarding topic aspects from the raw data. The information extraction agent 308 analyzes the topic information to identify aspects of the topic and details regarding each aspect. By converting unstructured data from the research agent 304 into a structured format identifying topic aspects, the information extraction agent 308 ensures that the information is organized for further downstream evaluation. Depending on the topic, a variety of different topic aspects can be identified by the information extraction agent 308. In some cases, a topic aspect can correspond with why the topic is trending. For instance, given an actor that is trending because of a recent movie release, topic aspects could be the movie being released, items/products in the movie, other actors in the movie, or anything else related to the movie. In some cases, a topic aspect can be independent of why the topic is trending. For instance, continuing the example of in which an actor is trending because of a recent movie release, topic aspects could be previous movies with the actor, the actor’s spouse, products endorsed by the actor, an outfit the actor wore in a recent public engagement, the actor’s hair style, or anything else related to the actor that is not also related to the movie.

The structured topic information from the information extraction agent 308 is then evaluated by the topic aspect evaluation agent 310, which assesses the relevance of each topic aspect identified in the structured topic information. The topic aspect evaluation agent 310 determines which topic aspects are most pertinent to the topic and/or the listing platform and should be included in a final set of topic aspects provided in topic aspect data 314 output from the operations 300. The evaluation process can involve analyzing the extracted information to ensure that only the most relevant and significant topic aspects are selected. The ability of the topic aspect evaluation agent 310 to accurately assess relevance of topic aspects for a given topic facilitates filtering out less important information and focusing on the key topic aspects for the topic. The topic aspect evaluation agent 310 validates how much of that information is actually useful/relevant and grades the results.

In some aspects, the topic aspect evaluation agent 310 generates a relevance score for each topic aspect based on the analysis and uses the relevance scores to select certain topic aspects for further analysis. This can include selecting the top N topic aspects (where N is a configurable number) with the highest relevance scores and/or comparing each relevance score to a relevance threshold to select only topic aspects with relevance scores satisfying the relevance threshold. In some configurations, multiple topic aspect evaluation agents are used to evaluate the topic aspects, and the selection of certain topic aspects is performed using agent voting.

For a topic aspect that is not selected (e.g., does not meet the relevance threshold), the system can perform additional analysis of the topic aspect. As shown in FIG. 3, the feedback agent 312 generates feedback for the topic aspect using information regarding the topic aspect and information from the topic aspect evaluation agent 310. This feedback is used to refine the search and extraction process. For instance, the feedback agent 312 can identify areas where the initial search or extraction may have fallen short and provides guidance on how to improve the results. The feedback agent 312 can suggest additional searches or adjustments to the extraction criteria to ensure that the most relevant information is captured. This iterative process helps to continuously improve the quality of the data, ensuring that the system can adapt and respond to new information effectively.

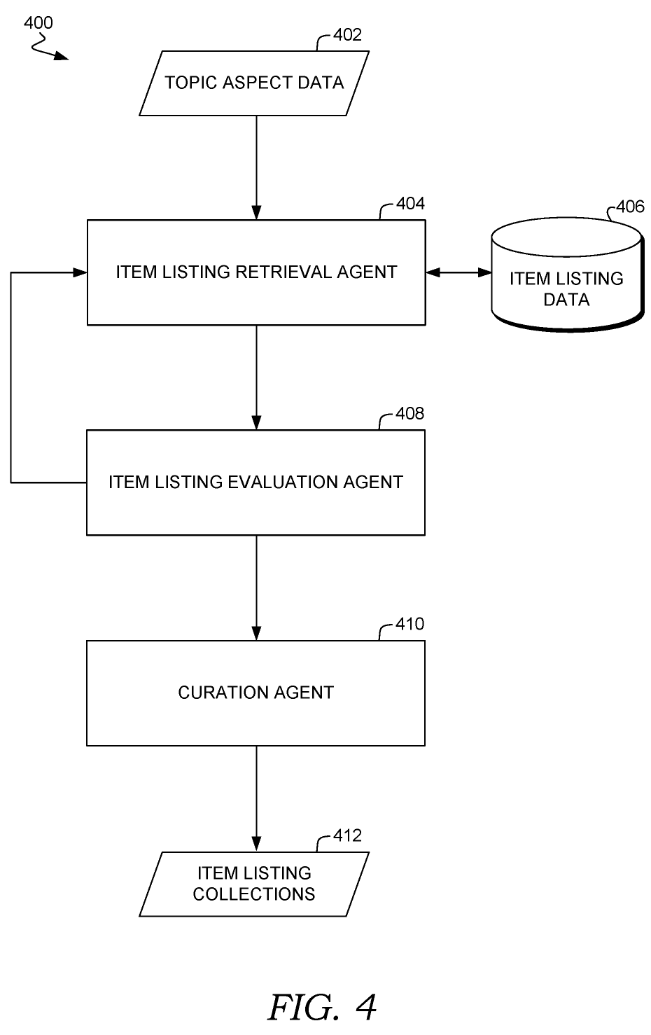

FIG. 4 provides a block diagram that illustrates example operations 400 for curating collections of item listings for selected topic aspects (e.g., selected by the operations 300 of FIG. 3) that can be performed, for instance, by the curation component 116 in accordance with some aspects of the technology described herein. The operations 400 are performed using a number of agents, including an item listing retrieval agent 404, an item listing evaluation agent 408, and a curation agent 410. While only a single item listing retrieval agent 404, a single item listing evaluation agent 408, and a single curation agent 410 are shown in FIG. 4, each can comprise one or more agents that perform the operations described herein.

As shown in FIG. 4, the operations 400 begin by accessing topic aspect data 402, which can include information regarding the topic, information regarding the selected topic aspects, and/or information regarding why the topic is trending. Using the topic aspect data 402, the item listing retrieval agent 404 searches for item listings from item listing data 406 for the listing platform that are related to each topic aspect. This can involve querying various databases of the listing platform to generate a set of candidate item listings for each topic aspect.

In some configurations, the item listing retrieval agent 404 can employ an approach such as that described in US Patent Application, 18/597,076, which is herein incorporated by reference in its entirety. For instance, the item listing retrieval agent 404 can generate a query using a topic aspect (e.g., via a generative model) that is then used to identify relevant item listings. In some aspects, this can include generating a query embedding based on a topic aspect and using the query embedding to identify similar item embeddings of item listings on the listing platform.

Once the item listings are identified, they are passed to the item listing evaluation agent 408, which assesses the relevance and quality of the retrieved item listings. The item listing evaluation agent 408 can evaluate each item listing based on its alignment with the topic aspects and the overall trending topic. For instance, the item listings can be evaluated based on the topic aspect and greater topic for relevancy and quality. In some aspects, the quality is measured by the item listing evaluation agent 408 using the item information from each item listing (and, in some case, also using the item images from each item listing) to grade the item listings and generate relevant feedback. After grading and generating feedback, the item listing evaluation agent 408 takes query-item listing pairs and applies the feedback for a given query (remove, modify, add, etc.) taking the full context of topic and specific topic aspects into consideration, as shown by the return from the item listing evaluation agent 408 to the item listing retrieval agent 404. This process can be repeated for each query until a passing grade is achieved or after a certain number of iterations.

After the system has identified the relevant set of queries, the associated item listings that are returned as search results from the queries are processed by the curation agent 410 to provide curated collections of item listings. In some aspects, the curation agent 410 merges and deduplicates the item listings, and then groups the item listings into different collections of item listings. The curation agent 410 ensures that the item listings are not only relevant but also presented in a way that is meaningful and useful to users. The curation agent 410 can group item listings based on themes, categories, or other logical criteria, creating curated collections that reflect different aspects of the trending topic. For instance, in some aspects, each collection is identified with a theme, and the theme for each collection can be based on a topic aspect common to item listings from that collection. In some configurations, multiple sets of collections are formed for each topic aspect. For a given topic aspect, this allows for different collections of item listings to be provided to users based on relevance to each user.

The output from the operations 400 are the item listing collections 412 from the curation agent 410. These item listing collections 412 are the curated sets of item listings. Each collection is designed to be highly relevant and of high quality to different aspects of the topic. The operations 400 can be performed for a number of different trending topics, providing a number of different sets of collections for different aspects of each trending topic.

The item listing collections 412 and/or the queries used to generate them are stored by a listing platform for item retrieval on the listing platform. In some aspects, the information is used for search. For instance, when a search engine of the listing platform receives search queries from users, the search engine can identify one or more of the item listing collections and/or their associated queries that are relevant to the search queries, and the search engine can return search results using the identified collection(a) and/or associated query. In some aspects, the search engine can employ user information (e.g., user demographics, user behavior information, and/or user preferences) to facilitate selection of item listings collections relevant to users based on relevance to their user information.

In some aspects, the item listing collections 412 and/or their corresponding queries are used for item recommendation on the listing platform. For instance, selected item listing collections can be used by the system to provide item listing recommendations presented on the homepage of the listing platform. For a given trending topic, in some case, all users may receive the same collection, while in other cases, different users can be provided different collections based on relevance of the collections to each user (e.g., based on user information, such as user demographics, user behavior information, and/or user preferences). As another example, the collections could be used to provide item recommendations for presentation on an item page (e.g., a product page) for an item listing when the collection is relevant to the item listing.

Turning again to FIG. 1, the custom topic component 118 of the topic tracking system 106 facilitates proactively tracking specific topics of interest specified by users by setting up automated monitoring systems. The custom topic component 118 enables users to define what they want to track, and the system configures agents to gather relevant data at specific timing intervals. As described in further detail below, the custom topic component 118 uses agents to perform multi-step reasoning and research, storing the gathered data in a dynamic schema and analyzing the gathered data for material changes relevant to the user input.

In some aspects, the custom topic component 118 can support custom topic tracking associated with the listing platform 104. For instance, a marketer or seller could specify a topic to track for triggering advertisements or for facilitating item retrieval on the listing platform 104. In other aspects, the custom topic component 118 can support custom topic tracking independent of the listing platform 104. For instance, a user could specify a custom topic for tracking such that the custom topic component 118 notifies the user of any material changes for the specified topic.

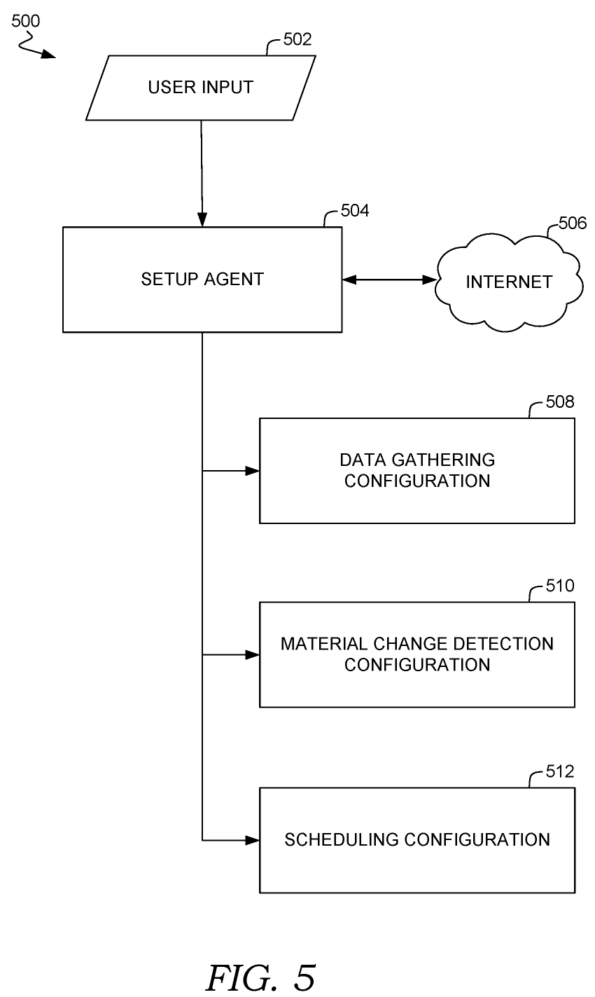

FIG. 5 provides a block diagram that illustrates example operations 500 for generating configuration information to track information for a custom topic that can be performed, for instance, by the custom topic component 118 in accordance with some aspects of the technology described herein. The operations 500 are performed using any number of agents, including a setup agent 504. While only a single setup agent 504 is shown in FIG. 5, the system can include any number of agents to perform the operations described herein.

As shown in FIG. 5, the operations 500 begin by accessing user input 502. The user input 502 can include natural language text specifying the user’s requirements. The user input 502 can identify a topic to be tracked by the system and, in some cases, certain aspects of the topic. For example, a user might want to track the deaths of major characters in the “House of the Dragon” series, including the episode air date and a short summary of the character.

The setup agent 504 performs multi-step information gathering and reasoning regarding the topic specified in the user input 502. In some aspects, the setup agent 504 comprises an internet-connected LLM that can access and retrieve information from the internet 506 in real-time. The setup agent 504 conducts internet searches to retrieve relevant information about the topic based on the user input 502 and can refine its search queries based on the information it gathers over multiple iterations, ensuring a comprehensive analysis of the topic. The topic information obtained by the setup agent 504 can comprise text (e.g., natural language text) regarding the topic in view of the user input. For instance, given the example user input above, the setup agent 504 can perform a number of searches to understand that the topic “House of Dragons” is a television series, when each episode airs, characters in the show, as well as additional information.

Based on the user input 502 and the information regarding the topic obtained from the internet searches, the setup agent 504 generates configurations for agents to track the topic and identify material changes to the topic. As shown in FIG. 5, this includes the setup agent 504 generating a data gathering configuration 508, a material change detection configuration 510, and a scheduling configuration 512.

The data gathering configuration 508 defines what data for the custom topic will be periodically collected. In particular, based on the user input 502 and the information regarding the topic obtained from the internet searches, the setup agent 504 can generate the data gathering configuration 508 to define specifications for gathering data for the topic. This can include, for instance, the data sources, the type of data to be gathered, and/or the storage format. The data gathering configuration 508 can also set forth a data structure for the various information to be gathered to be able to perform appropriate tracking of material changes. For example, given the example user input above regarding “House of Dragons”, the setup agent 504 can generate the data gathering configuration 508 to specify that the data to be gathered includes character deaths, including actor names, character names, seasons, and episodes, and that the gathered data is to be stored in a NoSQL database or other storage format that enables processing of the data to identify material changes. The setup agent 504 can also produce the following data structure to facilitate gathering relevant data: [run date, character name, actor name, season, episode, episode air date, character summary, character role size, season expected end date].

The material change detection configuration 510 defines how topic information obtained using the data gathering configuration 508 is to be analyzed to identify material changes. The setup agent 504 determines what constitutes a material change based on the user input 502 and generates the material change detection configuration 510 to capture those material changes by comparing newly gathered information with previous information. In some aspects, the material change detection configuration 510 can include natural language guidelines on what information would be material and produce a change event to be output by the system. For instance, continuing the “House of Dragons” example, the setup agent 504 can generate the material change detection configuration 510 to compare newly gathered information about the “House of Dragons” with previously gathered information to determine whether a character has died and, when a character has died, whether the character was a major character.

The scheduling configuration 512 defines timing data for scheduling runs in which data collection for the custom topic is performed using the data gathering configuration 508 and evaluated for material changes using the material change detection configuration 510. In various aspects, the setup agent 504 can determine the timing data based on: information specified in the user input 502, information regarding the topic that the setup agent 504 collected from the internet, and/or a default schedule. In some aspects, the timing data can comprise structured data on when the next run should be scheduled in the system. For instance, continuing the “House of Dragons” example, the setup agent 504 can generate the scheduling configuration 512 to gather relevant data after each new episode airs. In some cases, the scheduling configuration 512 can be adjusted based on external factors and the latest information regarding the topic, such as changes in the airing schedule of the series.

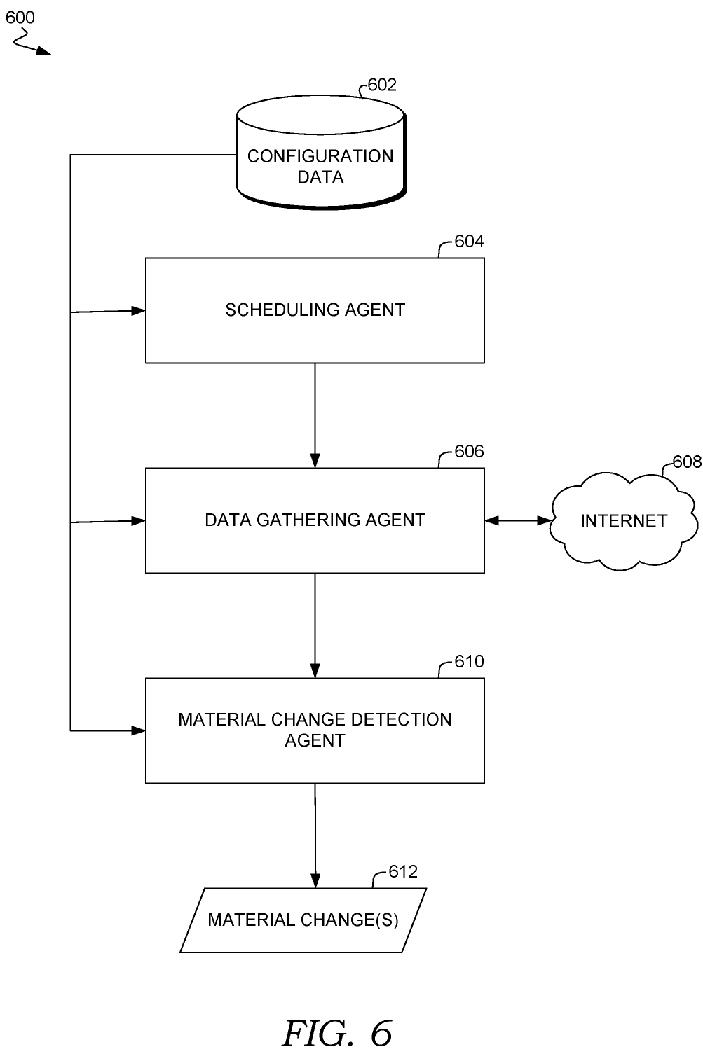

FIG. 6 provides a block diagram that illustrates example operations 600 to track a custom topic specified by user input and to identify material changes in the topic that can be performed, for instance, by the custom topic component 118 in accordance with some aspects of the technology described herein. The operations 600 are performed using a number of agents, including a scheduling agent 604, a data gathering agent 606, and a material change detection agent 610. While only a single scheduling agent 604, a single data gathering agent 606, and a single material change detection agent 610 are shown in FIG. 6, each can comprise one or more agents that perform the operations described herein.

As shown in FIG. 6, the operations 600 begin by configuring each of the agents with configuration data 602. The configuration data 602 can comprise, for instance, a configuration generated for each agent using the operations 500 of FIG. 5. For instance, the configuration data 602 can comprise a scheduling configuration for configuring the scheduling agent 604, a data gathering configuration for configuring the data gathering agent 606, and a material change detection configuration for configuring the material change detection agent 610.

Based on timing data in the configuration data 602 (e.g., the scheduling configuration 512 in FIG. 5) generated during an initial setup process, the scheduling agent 604 schedules runs. Each run involves collecting relevant information (by the data gathering agent 606) and evaluating the collected information for material changes (by the material change detection agent 610). For instance, continuing the “House of Dragons” example, the scheduling agent 604 could schedule the system to perform runs at specified intervals, such as weekly after each episode airs, until the season ends. In some aspects, the scheduling agent 604 can revise a schedule based on additional information gathered about the topic, for instance, when runs are performed.

Based on a data gathering configuration (e.g., the data gathering configuration 508 of FIG. 5) generated during an initial setup process, the data gathering agent 606 performs multi-step information gathering and reasoning regarding the customer topic. In some aspects, the data gathering agent 606 comprises an internet-connected LLM that can access and retrieve information from the internet 608 in real-time. This can include the data gathering agent 606 performing multiple internet searches to gather all the required information from various sources based on the specifications of what to search for from the configuration data 602. The data gathering agent 606 can conduct internet searches to retrieve relevant information about the custom topic and can refine its search queries based on the information it gathers over multiple iterations, ensuring a comprehensive analysis of the topic. In some aspects, the data gathering agent 606 attempts to collect data elements in accordance with a data structure specified for the custom topic in the initial setup and populates fields of the data structure with corresponding information. Continuing the example involving the “House of Dragons,” the data gathering agent 606 can search for information regarding the latest episode and populate the following fields: [run date, character name, actor name, season, episode, episode air date, character summary, character role size, season expected end date].

The material change detection agent 610 is configured to analyze the data collected by the data gathering agent based on material change specifications in the configuration data 602 (e.g., the material change detection configuration 510 of FIG. 5). The material change detection agent 610 analyzes the collected data to identify any material changes based the material change specifications. This can include comparing the new data against the previous information stored in a NoSQL database or other data structure and determines if any changes are material based on the specifications. For instance, continuing the “House of Dragons” example, the material change detection agent 610 could detect a major character’s death is new by comparing new data with previously stored data.

The output from operations 600 comprise any material changes 612 identified by the material change detection agent 610. In some aspects, when material changes 612 are identified, the system generates notification events. For instance, the system can provide a notification to a user device of the user about a major character’s death in a recent episode of the “House of Dragons.”

Returning again to FIG. 1, the topic tracking system 106 further includes a user interface component 120 that provides one or more user interfaces for interacting with the listing platform 104 and/or the topic tracking system 106. While shown as part of the topic tracking system 106 in FIG. 1, in some configurations, the user interface component 120 can be part of the listing platform 104. The user interface component 120 provides one or more user interfaces to a user device, such as the user device 102. In some instances, the user interfaces can be presented on the user device 102 via the application 108, which can be a web browser or a dedicated application for interacting with the listing platform 104 and/or the topic tracking system 106. For instance, the user interface component 120 can provide user interfaces for, among other things, presenting information regarding trending topics identified by the trending topic component 114 and/or curated collections of item listings for trending topics identified by the curation component 116. The user interface component 120 can also provide user interfaces that enable users to provide input regarding custom topics to be tracked by the custom topic component 118 and user interfaces providing notifications regarding material changes identified by the custom topic component 118.

### Example Methods for Agentic Topic Tracking and Understanding

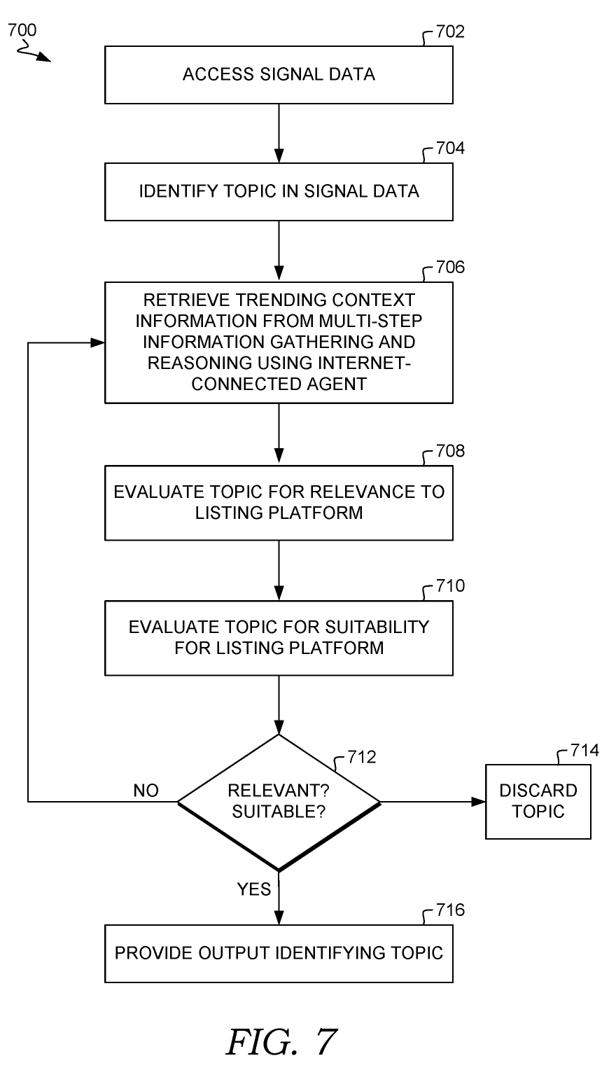

With reference now to FIG. 7, a flow diagram is provided that illustrates a method 700 for identifying trending topics that are relevant and suitable for a listing platform in accordance with some aspects. The method 700 may be performed at least in part, for instance, by the trending topic component 114 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, the method begins by accessing signal data from various online sources, such as social media sites, news sites, and search platforms. The signal data can include low-context information like keywords, hashtags, and search queries. This step involves gathering data that indicates one or more topics but lacks detailed context around the topics.

As shown at block 704, the system proceeds to identify a topic in the signal data. This identification can be performed using natural language processing (NLP) techniques to understand and interpret human language from online sources, extracting key phrases from the signal data. Machine learning algorithms can also be used to categorize this information, recognizing patterns and correlations that indicate trending topics. Social media analytics tools track engagement metrics such as likes, shares, and comments to gauge the popularity of specific topics. Web scraping enables the collection of data from websites, which can be processed to identify frequently discussed topics. Additionally, search engine analytics provide insights into what users are searching for, highlighting shifts in public interest. In some aspects, topics are selected for further analysis by analyzing frequency and patterns of the topics in the signal data. For instance, a topic could be selected based on identifying the topic as trending given an increase in occurrence of the topic in the signal data over a certain time period.

As shown at block 706, the system retrieves trending context information from multi-step information gathering and reasoning using an internet-connected agent. The agent conducts internet searches to retrieve relevant information about the topic, aiming to understand why the topic is trending. The agent can refine its search queries based on the information it gathers over multiple iterations, ensuring a comprehensive analysis of the topic. This process allows the agent to generate trending context information providing a detailed understanding of why the topic is trending. The trending context information output by the agent can comprise text describing the trending context for the topic, such as text that specifies one or more reasons why the topic is trending.

As shown at block 708, the system evaluates the topic for relevance to the listing platform. The topic relevance agent determines whether the topic is pertinent to item listings available on the listing platform. In some aspects, the topic is used alone when performing the topic relevance evaluation; while in other aspects, the trending context information generated by the research agent is also used when performing the topic relevance evaluation. The topic relevance agent employs the topic and/or trending context information to query the item listing data for the listing platform to identify item listings relevant to the topic. The topic relevance agent can determine an extent to which there are item listings available on the listing platform related to the topic and/or its corresponding trending context information such that the topic is relevant for performing item retrieval on the listing platform.

As shown at block 710, the system evaluates the topic for suitability for the listing platform. The topic suitability agent uses guidelines to evaluate the suitability of the topic based on its corresponding trending context information. The guidelines can comprise natural language text setting forth policies, standards, and/or other requirements for determining the suitability of topics for the listing platform. The topic suitability agent processes the topic and its trending context information to determine whether they align with the policies, standards, or other requirements specified by the guidelines. In some aspects, the topic suitability agent can generate a suitability score based on an extent to which the topic and its trending context information comport with the guidelines. The suitability score can be compared to a suitability threshold to determine if the topic and its trending context are suitable and therefore should be considered for further analysis.

As shown at block 712, the system determines whether the topic is relevant and suitable for the listing platform. If the topic is determined to be irrelevant or unsuitable, the research agent can be instructed to gather additional trending context information by performing additional multi-step information gathering and reasoning regarding the topic. After additional trending context information is gathered, the topic can be evaluated again for relevance and/or suitability using the additional trending context information. This can be performed over several iterations until the topic is determined to be relevant and suitable or until a certain number of iterations have been performed, in which case the topic can be considered irrelevant and/or unsuitable for the listing platform and discarded, as shown at block 714.

As shown at block 716, if the topic is found to be relevant and suitable, the system provides an output identifying the topic. The topic output can include the reasons why the topic is trending. In some aspects, the system provides an indication of the topic (with or without an indication of the reasons why the topic is trending), which is displayed on a user device of an administrator of the listing platform. This allows the administrator to review the topic and/or reasons why the topic is trending to determine whether to use the topic for item retrieval purposes on the listing platform. In some aspects, the topic output is provided to downstream operations to facilitate item retrieval on the listing platform relevant to the topic. This enables the listing platform to offer timely and relevant item listings based on trending topics, enhancing the item retrieval relevance for the listing platform. In some aspects, when a search engine of the listing platform receives search queries from users, the search engine can identify search queries that are relevant to trending topics and employ the trending topics to select/rank item listings to return as search results. Trending topics can also be used to select item listing recommendations to provide to user devices accessing the listing platform.

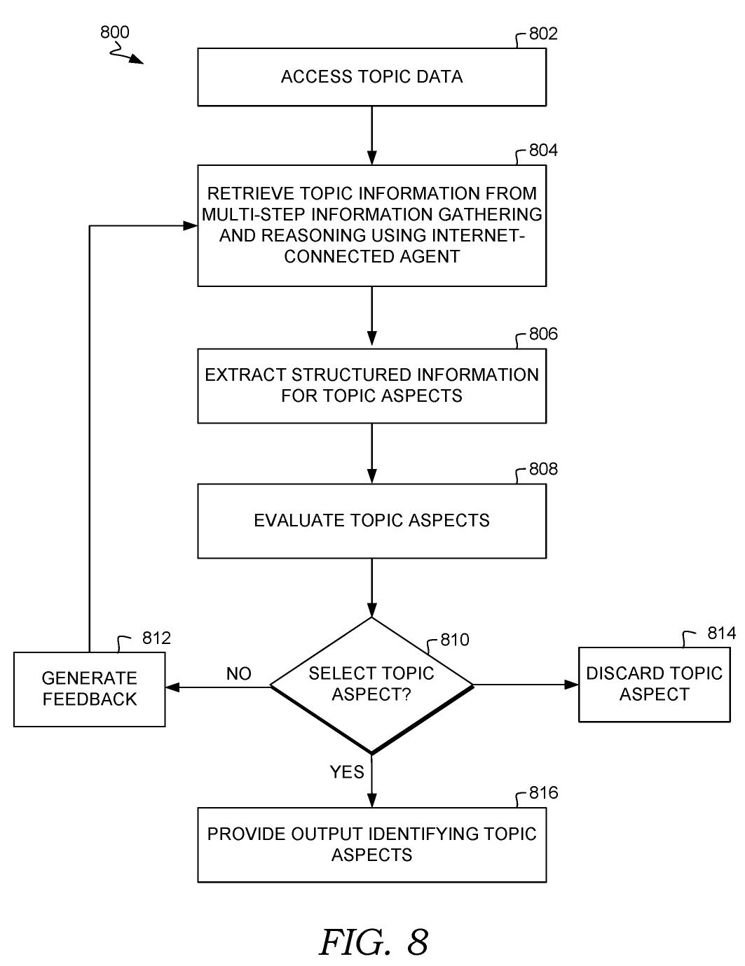

Turning next to FIG. 8, a flow diagram is provided showing a method 800 for identifying relevant topic aspects of a trending topic. The method 800 can be performed at least in part, for instance, by the curation component 116 of FIG. 1. As shown at block 802, the system access topic data for a given topic. This topic data can include an indication of the topic or additional information such as trending context information. The topic can be identified as relevant and suitable using prior operations. The topic data serves as the foundation for subsequent steps in the method, ensuring that the topic is accurately represented and understood before further processing.

As shown at block 804, the system performs multi-step information gathering and reasoning using an internet-connected agent. This agent conducts internet searches to retrieve relevant information about the topic and refines its search queries based on the gathered information over multiple iterations. The agent ensures a comprehensive analysis of the topic by generating topic information that provides a collection of information regarding the topic, which can be used to identify topic aspects for item retrieval.

As shown at block 806, the system extracts structured information for topic aspects from the gathered topic information. An information extraction agent processes the raw data to identify aspects of the topic and details regarding each aspect. By converting unstructured data into a structured format, the agent ensures that the information is organized for further downstream evaluation. Depending on the topic, various topic aspects can be identified, which may correspond with why the topic is trending or be independent of the trending reason.

As shown at block 808, the system evaluates the structured information for the topic aspects to determine the relevance of each aspect. A topic aspect evaluation agent assesses the relevance of each identified topic aspect, determining which aspects are most pertinent to the topic and/or the listing platform. The evaluation process involves analyzing the extracted information to ensure that only the most relevant and significant topic aspects are selected. This step facilitates filtering out less important information and focusing on key aspects.

As shown at block 810, the system selects a subset of topic aspects based on their relevance. The selection process can involve generating relevance scores for each topic aspect and using these scores to select certain aspects for further analysis. The selection can be performed using agent voting or by comparing relevance scores to a threshold. This ensures that the final set of topic aspects provided in the topic aspect data is highly relevant.

For any topic aspects that are not selected, as shown at block 812, the system generates feedback. A feedback agent generates feedback using information regarding the topic aspect and information from the topic aspect evaluation agent. This feedback is used to refine the search and extraction process, suggesting additional searches or adjustments to ensure that the most relevant information is captured. This iterative process helps improve the quality of the data continuously, refining the topic aspects until they meet the relevance criteria. If a topic aspect is not selected after a number of iterations, the topic aspect is discarded, as shown at block 814. As shown at block 816, the method concludes by providing an output identifying the selected topic aspects. The final set of topic aspects can be used for item retrieval on the listing platform.

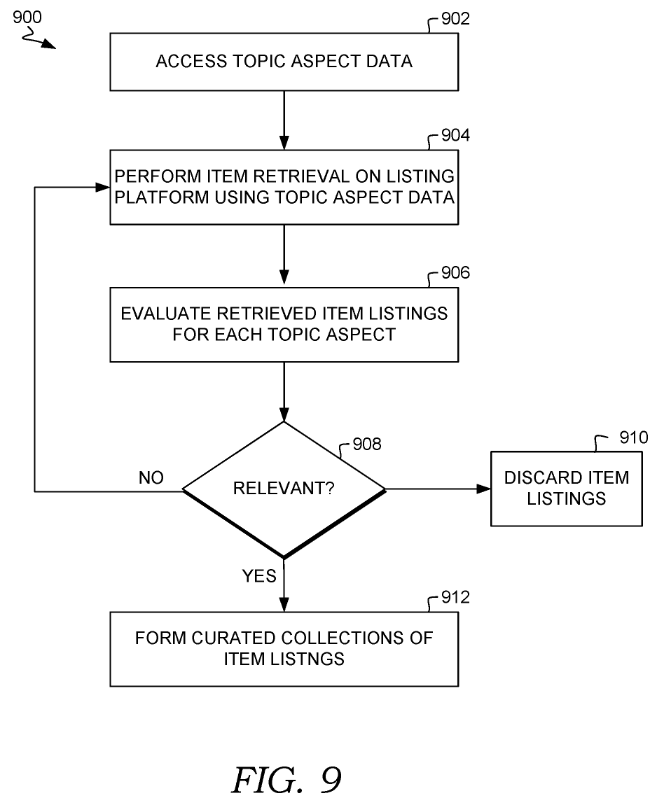

Turning next to FIG. 9, a flow diagram is provided showing a method 900 for curating collections of item listings for selected topic aspects. The method 900 can be performed at least in part, for instance, by the curation component 116 of FIG. 1. As shown at block 902, the method begins by accessing topic aspect data. This data is used to perform item retrieval on a listing platform. The topic aspect data can include information regarding the topic, information regarding selected topic aspects, and/or information regarding why the topic is trending.

As shown at block 904, the system performs item retrieval on the listing platform using the topic aspect data. This step includes querying various databases of the listing platform to generate a set of candidate item listings for each topic aspect. The item retrieval process can employ approaches such as generating a query using a topic aspect and using the query to identify relevant item listings. This can include generating a query embedding based on a topic aspect and using the query embedding to identify similar item embeddings of item listings on the listing platform.

As shown at block 906, the system evaluates the retrieved item listings for each topic aspect. This evaluation assesses the relevance and quality of the retrieved item listings. The evaluation process can involve analyzing the item listings based on their alignment with the topic aspects and the overall trending topic. The item listings can be evaluated based on the topic aspect and greater topic for relevancy and quality. The quality is measured using the item information from each item listing to grade the item listings and generate relevant feedback.

As shown at block 908, the system determines whether the retrieved item listings are relevant. If the item listings are not relevant, they are discarded, as shown at block 910. The discarding process ensures that only the most relevant and high-quality item listings are retained for further processing.

As shown at block 912, the system forms curated collections of item listings. In some aspects, the curated collections are generated by merging and deduplicating the item listings and then grouping them into different collections based on themes, categories, or other logical criteria. The curated collections reflect different aspects of the trending topic and are designed to be highly relevant and of high quality. Each collection is identified with a theme or other identifier, and the theme/identifier for each collection can be based on a topic aspect common to item listings from that collection. In some cases, multiple sets of collections can be formed for each topic aspect, allowing for different collections of item listings to be provided to users based on relevance to each user.

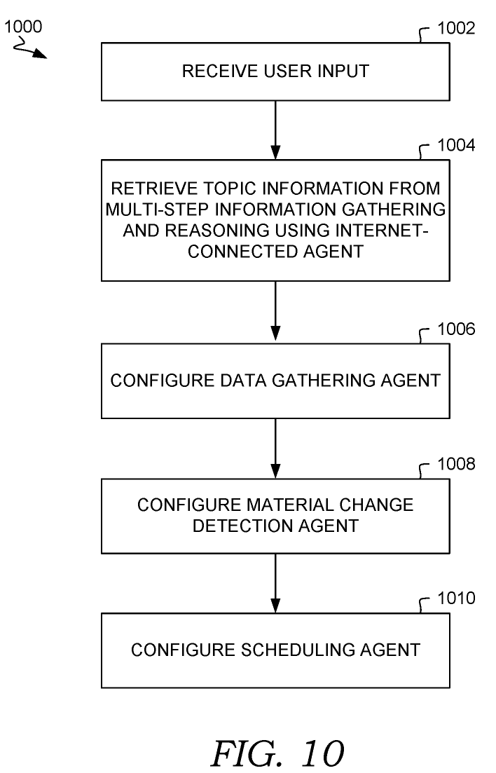

Turning next to FIG. 10, a flow diagram is provided showing a method 1000 for generating configuration information to track information for a custom topic. The method 1000 can be performed at least in part, for instance, by the custom topic component 118 of FIG. 1. As shown at block 1002, the method begins with receiving natural language input from a user identifying a topic to be tracked. This step involves the user providing specific requirements or interests in natural language form, which the system interprets to determine the topic of interest. The user input can include various details about the topic, such as specific aspects to be monitored or tracked.

As shown at block 1004, the method proceeds with retrieving initial information from the internet regarding the topic. This involves using a setup agent to perform multi-step information gathering and reasoning. The setup agent conducts internet searches iteratively to gather comprehensive information about the specified topic. The agent refines its search queries based on the information it gathers, ensuring a thorough understanding of the topic.

As shown at block 1006, the system configures a data gathering agent. Based on the initial information retrieved, the setup agent generates a data gathering configuration that defines the specifications for the data to be collected. This configuration includes details such as data sources, types of data, and storage formats. The data gathering agent is configured to periodically collect relevant data according to these specifications.

As shown at block 1008, the system configures a material change detection agent. The setup agent generates a material change detection configuration that defines what constitutes a material change based on the user input. This configuration includes guidelines for comparing newly gathered information with existing data to identify significant changes. The material change detection agent uses this configuration to analyze the collected data and determine if any changes are material.

As shown at block 1010, the method includes configuring a scheduling agent. The setup agent generates a scheduling configuration that defines the timing for performing scheduled runs. This configuration is based on factors such as user input, initial information retrieved, and default schedules. The scheduling agent uses this configuration to determine when to initiate data collection and analysis runs.

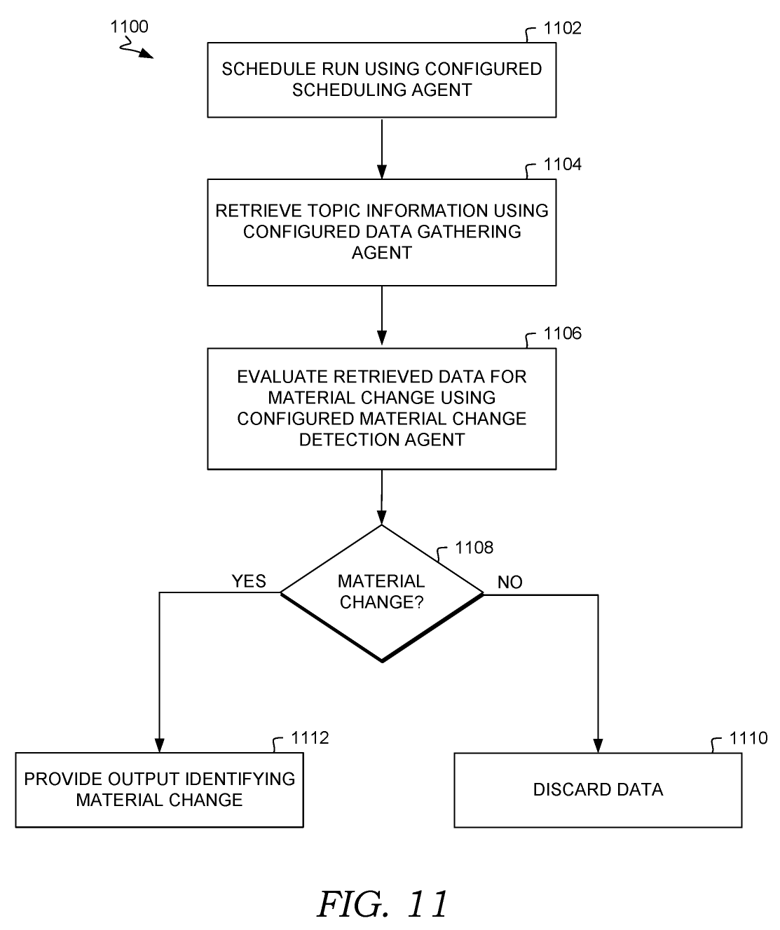

Turning next to FIG. 11, a flow diagram is provided showing a method 1100 for tracking a custom topic specified by user input and identifying material changes in the topic. The method 1100 can be performed at least in part, for instance, by the custom topic component 118 of FIG. 1. As shown at block 1102, the method begins with scheduling a run using a configured scheduling agent. This step involves setting up the timing and frequency for the data collection and analysis process. The scheduling agent is configured based on timing data, which can be derived from, for instance, user input, initial information retrieved from the internet, or a default schedule. The scheduling agent ensures that the runs are performed at appropriate intervals to gather relevant information and evaluate it for material changes.

As shown at block 1104, the system retrieves topic information using a configured data gathering agent. This step involves the data gathering agent performing multi-step reasoning and research to collect information about the specified topic. The data gathering agent uses configurations that define the data sources, types of data to be gathered, and the storage format. The agent conducts internet searches and refines its queries based on the gathered information to ensure comprehensive coverage of the topic. The gathered data is then stored in a structured format for further analysis.

As shown at block 1106, the system evaluates the retrieved data for material changes using a configured material change detection agent. This step involves analyzing the collected data to identify any significant changes based on predefined criteria. The material change detection agent compares the new data with previously stored information to determine if any changes are material. The agent uses specifications that define what constitutes a material change, ensuring that only relevant changes are flagged for further action.

As shown at block 1108, the system determines whether the retrieved data contains material changes. This decision-making step involves assessing the quality and significance of the data. If the data is deemed to not contain any material changes, the data is discarded, as shown at block 1110.

Alternative, if any material changes are identified, the system provides an output identifying the detected material changes, as shown at block 1112. This step involves generating notifications or reports based on the identified material changes. The output can include detailed information about the changes, such as the nature of the change, its impact, and any relevant context. This information is communicated to the user or other systems for further action or decision-making.

### Exemplary Operating Environment

Having described implementations of the present disclosure, an exemplary operating environment in which embodiments of the present technology may be implemented is described below in order to provide a general context for various aspects of the present disclosure. Referring initially to FIG. 12 in particular, an exemplary operating environment for implementing embodiments of the present technology is shown and designated generally as computing device 1200. Computing device 1200 is but one example of a suitable computing environment and is not intended to suggest any limitation as to the scope of use or functionality of the technology. Neither should the computing device 1200 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 12, computing device 1200 includes bus 1210 that directly or indirectly couples the following devices: memory 1212, one or more processors 1214, one or more presentation components 1216, input/output (I/O) ports 1218, input/output components 1220, and illustrative power supply 1222. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 12 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1212 includes computer storage media in the form of volatile and/or nonvolatile memory. The memory may be removable, non-removable, or a combination thereof. Exemplary hardware devices include solid-state memory, hard drives, optical-disc drives, etc. Computing device 1200 includes one or more processors that read data from various entities such as memory 1212 or I/O components 1220. Presentation component(s) 1216 present data indications to a user or other device. Exemplary presentation components include a display device, speaker, printing component, vibrating component, etc.

I/O ports 1218 allow computing device 1200 to be logically coupled to other devices including I/O components 1220, some of which may be built in. Illustrative components include a microphone, joystick, game pad, satellite dish, scanner, printer, wireless device, etc. The I/O components 1220 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1200. The computing device 1200 may be equipped with depth cameras, such as, stereoscopic camera systems, infrared camera systems, RGB camera systems, and combinations of these for gesture detection and recognition. Additionally, the computing device 1200 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving an indication of a trending topic;
causing a first agent to perform one or more internet searches to retrieve information regarding the trending topic;causing a second agent to extract structured information for a plurality of topic aspects from the retrieved information;causing a third agent to evaluate the structured information for the plurality of topic aspects to determine a relevance of each topic aspect;selecting a subset of topic aspects from the plurality of topic aspects based on the relevance of each topic aspect;identifying, from item listing data for a listing platform, a set of item listings for a first topic aspect from the subset of topic aspects; andproviding an indication of the first topic aspect and the set of item listings for the first topic aspect for presentation on a user device.

2. The one or more computer storage media of claim 1, wherein the operations further comprise:
in response to the relevance for a second topic aspect from the plurality of topic aspects not satisfying a relevance threshold, causing a fourth agent to generate feedback for the second topic aspect;causing the first agent to perform one or more additional internet searches to retrieve additional information regarding the second topic aspect based on the feedback;causing the second agent to extract additional structured information for the second topic aspect from the retrieved additional information; causing the third agent to evaluate the additional structured information for the second topic aspect to determine an updated relevance for the second topic aspect; andincluding the second topic aspect in the subset of topic aspects based on the updated relevance.

3. The one or more computer storage media of claim 1, wherein identifying the set of item listings for the first topic aspect from the subset of topic aspects comprises:
performing a search to obtain an initial set of item listings for the first topic aspect;causing a fourth agent to evaluate the initial set of item listings; andperforming a refined search to obtain the set of item listings based on an output from the fourth agent.

4. The one or more computer storage media of claim 3, wherein the fourth agent is instructed to evaluate the initial set of item listings for relevance to the trending topic and the first topic aspect.

5. The one or more computer storage media of claim 4, wherein the fourth agent evaluates each item recommendation from the initial set of item listings by comparing item information for each item to the structured information for the trending topic and the first topic aspect.

6. The one or more computer storage media of claim 1, wherein the operations further comprise:
performing a search on the item listing data for the listing platform to obtain a second set of item listings for a second topic aspect from the subset of topic aspects;causing a fourth agent to evaluate the second set of item listings for the second topic aspect; anddetermining to discard the second topic aspect based on an output from the fourth agent.

7. The one or more computer storage media of claim 1, wherein the indication of the first topic aspect and the set of item listings for the first topic aspect are selected for a user of the user device based on a user profile for the user, the user profile comprising at least one selected from the following: user demographic information, past user behavior information, and user preferences.

8. A computer-implemented method comprising:
receiving an indication of a trending topic;performing, by a first agent, one or more internet searches to retrieve information regarding the trending topic;extracting, by a second agent, structured information for a plurality of topic aspects from the retrieved information;evaluating, by a third agent, the structured information for the plurality of topic aspects to determine a relevance score for each topic aspect;selecting a subset of topic aspects from the plurality of topic aspects based on the relevance score for each topic aspect;identifying, from item listing data for a listing platform, a set of item listings for a first topic aspect from the subset of topic aspects; andproviding an indication of the first topic aspect and the set of item listings for the first topic aspect for presentation on a user device.

9. The computer-implemented method of claim 8, wherein the method further comprises:
in response to the relevance for a second topic aspect from the plurality of topic aspects not satisfying a relevance threshold, generating, by a fourth agent, feedback for the second topic aspect;performing, by the first agent, one or more additional internet searches to retrieve additional information regarding the second topic aspect based on the feedback;extracting, by the second agent, additional structured information for the second topic aspect from the retrieved additional information; evaluating, by the third agent, the additional structured information for the second topic aspect to determine an updated relevance for the second topic aspect; andincluding the second topic aspect in the subset of topic aspects based on the updated relevance.

10. The computer-implemented method of claim 8, wherein identifying the set of item listings for the first topic aspect from the subset of topic aspects comprises:
performing a search to obtain an initial set of item listings for the first topic aspect;evaluating, by a fourth agent, the initial set of item listings; andperforming a refined search to obtain the set of item listings based on an output from the fourth agent.

11. The computer-implemented method of claim 10, wherein the fourth agent is instructed to evaluate the initial set of item listings for relevance to the trending topic and the first topic aspect.

12. The computer-implemented method of claim 11, wherein the fourth agent evaluates each item recommendation from the initial set of item listings by comparing item information for each item to the structured information for the trending topic and the first topic aspect.

13. The computer-implemented method of claim 8, wherein the method further comprises:
performing a search on the item listing data for the listing platform to obtain a second set of item listings for a second topic aspect from the subset of topic aspects;evaluating, by a fourth agent, the second set of item listings for the second topic aspect; anddetermining to discard the second topic aspect based on an output from the fourth agent.

14. The computer-implemented method of claim 8, wherein the indication of the first topic aspect and the set of item listings for the first topic aspect are selected for a user of the user device based on a user profile for the user, the user profile comprising at least one selected from the following: user demographic information, past user behavior information, and user preferences.

15. A computer system comprising:
one or more processors; andone or more computer storage media storing computer-useable instructions that, when used by the one or more processors, cause the computer system to perform operations, the operations comprising:
receiving an indication of a trending topic;
causing a first agent to perform one or more internet searches to retrieve information regarding the trending topic;causing a second agent to extract structured information for a plurality of topic aspects from the retrieved information;causing a third agent to evaluate the structured information for the plurality of topic aspects to determine a relevance of each topic aspect;selecting a subset of topic aspects from the plurality of topic aspects based on the relevance of each topic aspect;identifying, from item listing data for a listing platform, a set of item listings for a first topic aspect from the subset of topic aspects; andproviding an indication of the first topic aspect and the set of item listings for the first topic aspect for presentation on a user device.

16. The computer system of claim 15, wherein the operations further comprise:
in response to the relevance for a second topic aspect from the plurality of topic aspects not satisfying a relevance threshold, causing a fourth agent to generate feedback for the second topic aspect;causing the first agent to perform one or more additional internet searches to retrieve additional information regarding the second topic aspect based on the feedback;causing the second agent to extract additional structured information for the second topic aspect from the retrieved additional information; causing the third agent to evaluate the additional structured information for the second topic aspect to determine an updated relevance for the second topic aspect; andincluding the second topic aspect in the subset of topic aspects based on the updated relevance.

17. The computer system of claim 15, wherein identifying the set of item listings for the first topic aspect from the subset of topic aspects comprises:
performing a search to obtain an initial set of item listings for the first topic aspect;causing a fourth agent to evaluate the initial set of item listings; andperforming a refined search to obtain the set of item listings based on an output from the fourth agent.

18. The computer system of claim 17, wherein the fourth agent is instructed to evaluate the initial set of item listings for relevance to the trending topic and the first topic aspect, and wherein the fourth agent evaluates each item recommendation from the initial set of item listings by comparing item information for each item to the structured information for the trending topic and the first topic aspect.

19. The computer system of claim 15, wherein the operations further comprise:
performing a search on the item listing data for the listing platform to obtain a second set of item listings for a second topic aspect from the subset of topic aspects;causing a fourth agent to evaluate the second set of item listings for the second topic aspect; anddetermining to discard the second topic aspect based on an output from the fourth agent.

20. The computer system of claim 15, wherein the indication of the first topic aspect and the set of item listings for the first topic aspect are selected for a user of the user device based on a user profile for the user, the user profile comprising at least one selected from the following: user demographic information, past user behavior information, and user preferences.
